(19) United States
(12) Patent Application Publication
(10) Pub. No.: US 2015/0242678 A1
(43) Pub. Date: Aug. 27, 2015

(54) METHOD AND APPARATUS OF RECOGNIZING FACIAL EXPRESSION USING ADAPTIVE DECISION TREE BASED ON LOCAL FEATURE EXTRACTION

(71) Applicants: Electronics and Telecommunications Research Institute, Daejeon-si (KR); Industry-Academic Cooperation Foundation, Yonsei University, Seoul (KR)

(72) Inventors: In Jae LEE, Daejeon (KR); Chung Hyun AHN, Daejeon (KR); Ji Hun CHA, Daejeon (KR); Sang Youn LEE, Seoul (KR); Ji Hun OH, Seoul (KR); Yu Seok BAN, Seoul (KR)

(73) Assignees: ELECTRONICS AND TELECOMMUNICATIONS RESEARCH INSTITUTE, Daejeon-si (KR); INDUSTRY-ACADEMIC COOPERATION FOUNDATION, YONSEI UNIVERSITY, Seoul (KR)

(21) Appl. No.: 14/598,407

(22) Filed: Jan. 16, 2015

(30) Foreign Application Priority Data
Feb. 21, 2014 (KR) 10-2014-0020687

(51) Int. Cl. G06K 9/00; G06T 7/00; G06K 9/62

(52) U.S. Cl. CPC G06K 9/00302; G06K 9/00281; G06K 9/6282; G06K 9/6262; G06T 7/0081; G06T 7/0089; G06T 2207/20124; G06T 2207/30201

(57) ABSTRACT

A method and apparatus of recognizing a facial expression using a local feature-based adaptive decision tree are provided. A method of recognizing a facial expression by a facial expression recognition apparatus may include splitting a facial region included in an input image into local regions, extracting a facial expression feature from each of the local regions using a preset feature extracting algorithm, and recognizing a facial expression from the input image using the extracted facial expression feature based on a decision tree generated by repeatedly classifying facial expressions into two classes until one facial expression is contained in one class and determining a facial expression feature for a corresponding classification.

This application claims the benefit of Korean Patent Application No. 10-2014-0020687, filed on Feb. 21, 2014, in the Korean Intellectual Property Office, the entire disclosure of which is incorporated by reference herein.

### BACKGROUND OF THE INVENTION

1. Technical Field

Embodiments of the present invention concern a method and apparatus of effectively recognizing sentimental information through a facial expression.

2. Discussion of Related Art

Facial expression recognition is a technique of recognizing a specific sentiment by analyzing a facial expression contained in a user's image. As an example, Korean Patent Application Publication No. 10-2013-0015958, titled “sentiment recognizing apparatus using facial expression, sentiment recognizing method, and recording medium thereof,” (published on Feb. 14, 2013) discloses recognizing a sentiment expressed by an object by receiving information of the object responsive to an offered stimulus to recognize the face of the object, extracting the recognized object's facial element, and recognizing a change in a facial expression corresponding to the stimulus based on the extracted facial element.

As such, to recognize a facial expression, it is typically required to obtain a facial image per facial expression, extracting a feature by which facial expressions can be extracted from the obtained facial image, and classifying the facial expressions using the extracted feature. Obtaining the facial image is the step of detecting only a facial portion from the input image in order to extract the feature. Extracting the feature is the step of discovering information specific to a facial expression from the facial portion for well classifying facial expressions and is critical in recognizing a facial expression. Classifying the facial expressions is the step of classifying facial expression images according to certain sentiments by applying a classifying algorithm based on the feature extracted on each facial expression. However, the conventional facial expression recognition techniques simultaneously classify all facial expressions based on a feature determined according to each facial expression, thus leading to an increased recognition error.

### SUMMARY OF THE INVENTION

An object of the present invention is to provide a method of recognizing a facial expression using an adaptive decision tree based on a local feature, which allows for more efficient facial expression recognition than existing facial expression recognition schemes.

Another object of the present invention is to provide an apparatus of recognizing a facial expression using an adaptive decision tree based on a local feature, which allows for more efficient facial expression recognition than existing facial expression recognition schemes.

According to an aspect of the present invention, a method of recognizing a facial expression by a facial expression recognition apparatus may comprise splitting a facial region included in an input image into local regions, extracting a facial expression feature from each of the local regions using a preset feature extracting algorithm, and recognizing a facial expression from the input image using the extracted facial expression feature based on a decision tree generated by repeatedly classifying facial expressions into two classes until one facial expression is contained in one class and determining a facial expression feature for a corresponding classification.

In an aspect, splitting into the local regions may include detecting the facial region from the input image using an ASM (Active Shape Model) and splitting the detected facial region into the local regions.

In another aspect, the feature extracting algorithm may be any one of an LBP (Local Binary Pattern)-based algorithm and an eigenface algorithm.

In still another aspect, the decision tree may be generated based on the number of true recognitions computed per local region according to two facial expression combinations classified from each of the facial expressions.

In yet still another aspect, the number of true recognitions may be computed by determining whether true recognition is conducted on the classification based on a discriminant feature extracted from a training image.

In yet still another aspect, the discriminant feature may be extracted by applying at least one or more of a PCA (Principal Component Analysis) algorithm and an LDA (Linear Discriminant Analysis) algorithm or an SVM (Support Vector Machine) algorithm per facial expression feature extracted from the training image.

In yet still another aspect, the decision tree may be generated by repeatedly performing a process of classifying the facial expressions into two classes based on the facial expression combination so that an average of sums of the numbers of the true recognitions is maximized and determining a facial expression feature for a corresponding classification.

According to another aspect of the present invention, a facial expression recognition apparatus may comprise a splitting unit splitting a facial region included in an input image into local regions, an extracting unit extracting a facial expression feature from each of the local regions using a preset feature extracting algorithm, and a recognizing unit recognizing a facial expression from the input image using the extracted facial expression feature based on a decision tree generated by repeatedly classifying facial expressions into two classes until one facial expression is contained in one class and determining a facial expression feature for a corresponding classification.

According to still another aspect of the present invention, a method of generating a decision tree for facial expression recognition by a facial expression recognition apparatus may comprise splitting a facial region included in a training image into local regions, extracting a facial expression feature from each of the local regions using a preset feature extracting algorithm, extracting a discriminant feature for determining whether true recognition is conducted on a facial expression classification from the facial expression feature, classifying facial expressions into two facial expression combinations per facial expression feature and computing the number of per-local region true recognitions for each classification based on the discriminant feature, and classifying the facial expressions into two classes based on the number of the true recognitions and determining a facial expression feature for a corresponding classification.

The process of determining a local feature and branch specified to a facial expression classification is repeatedly performed to generate an adaptive decision tree that is then used to recognize a facial expression. Accordingly, an error recognition rate is reduced, thus allowing for efficient facial expression recognition.

### BRIEF DESCRIPTION OF DRAWINGS

FIG. 1 is a flowchart illustrating a method of generating a decision tree for facial expression recognition according to an embodiment of the present invention;

FIG. 2 is a flowchart illustrating a method of recognizing a facial expression according to an embodiment of the present invention;

FIG. 3 is a view illustrating facial expression combinations when six facial expressions are classified into two according to an embodiment of the present invention;

FIGS. 4 and 5 are views illustrating an example process of generating a decision tree according to an embodiment of the present invention;

FIG. 6 is a view illustrating an example decision tree according to an embodiment of the present invention;

FIG. 7 is a block diagram illustrating a facial expression recognition apparatus according to an embodiment of the present invention; and

FIG. 8 is a block diagram illustrating a computer system including a facial expression recognition apparatus according to an embodiment of the present invention.

### DETAILED DESCRIPTION OF EMBODIMENTS

Hereinafter, embodiments of the present invention are described below in detail with reference to the accompanying drawings so that the embodiments can be easily practiced by one of ordinary skill in the art. However, various changes may be made without being limited thereto. What is irrelevant to the present invention was skipped from the description for clarity, and like reference denotations are used to refer to like or similar elements throughout the specification.

As used herein, when an element “includes” another element, the element may further have the other element unless stated otherwise. As used herein, the term “unit” denotes a unit of performing at least one function or operation and may be implemented in hardware, software, or a combination thereof.

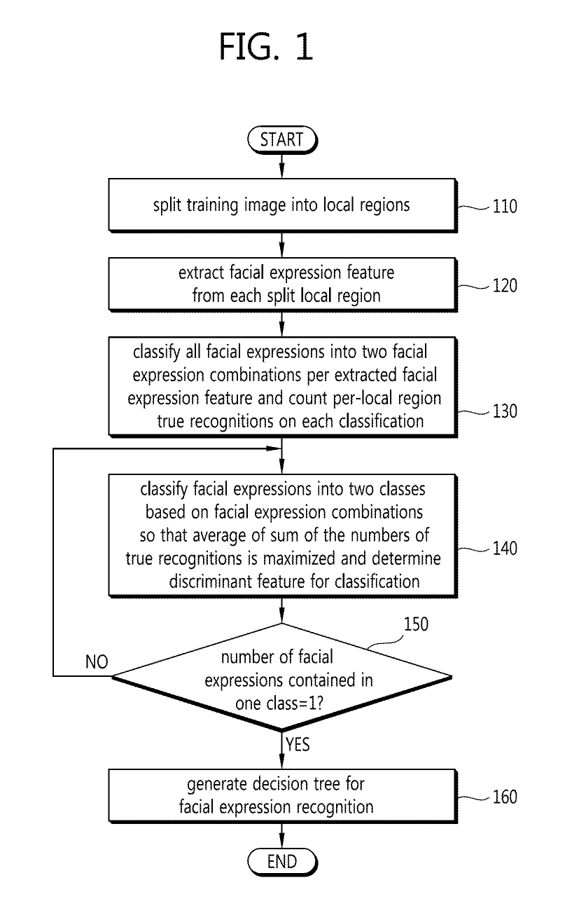

FIG. 1 is a flowchart illustrating a method of generating a decision tree for facial expression recognition according to an embodiment of the present invention.

In order for more efficient facial expression recognition, the facial expression recognition apparatus according to the present invention uses an adaptively generated decision tree. The decision tree may be generated by the facial expression recognition apparatus, and as necessary, may be generated by a separate apparatus. In case the decision tree is generated by the separate apparatus, the facial expression recognition apparatus may receive the decision tree from the separate apparatus in order for efficient facial expression recognition of a user. Hereinafter, an example of generating the decision tree by the facial expression recognition apparatus is described.

In order to generate the decision tree, the facial expression recognition apparatus first splits a facial region contained in a training image into local regions that allow for well recognition of facial expressions (step 110). For such purpose, the facial expression recognition apparatus uses, e.g., an ASM (Active Shape Model) to detect coordinates of major featuring points from the facial region and splits the facial region into major local regions such as a mouth region, an eye region, a nose region, a chick region, a between-eyebrow region, and a forehead region using the detected coordinates.

When the training image is split into the local regions, the facial expression recognition apparatus uses a predetermined feature extracting algorithm to extract facial expression features from each local region (step 120). For such purpose, the facial expression recognition apparatus may use, e.g., an LBP (Local Binary Pattern) algorithm, a ULBP (Uniform LBP) utilizing a uniform pattern, other LBP-based algorithm, and an eigenface algorithm.

When the facial expression feature is extracted from each local region split from the training image through the afore-described process, the facial expression recognition apparatus extracts a discriminant feature for determining whether true recognition is conducted on the facial expression classification from each of the extracted facial expression features while classifying all facial expressions into two facial expression combinations per facial expression feature. Based on the discriminant feature, the facial expression recognition apparatus counts true recognitions on each classification (step 130), classifies the facial expressions into two classes so that the average of sums of the number of true recognitions is maximized, and determines a facial expression feature (or local region) for the classification (step 140). Here, the discriminant feature may be extracted using at least one algorithm of an LDA (Linear Discriminant Analysis) and an SVM (Support Vector Machine) together with a PCA (Principal Component Analysis) per facial expression feature.

Hereinafter, the facial expression recognition apparatus classifies the facial expressions into two classes and repeatedly performs a process of determining a facial expression feature (or local region) for the classification until each facial expression is contained in one class (step 150) to thus generate a decision tree for facial expression recognition (step 160).

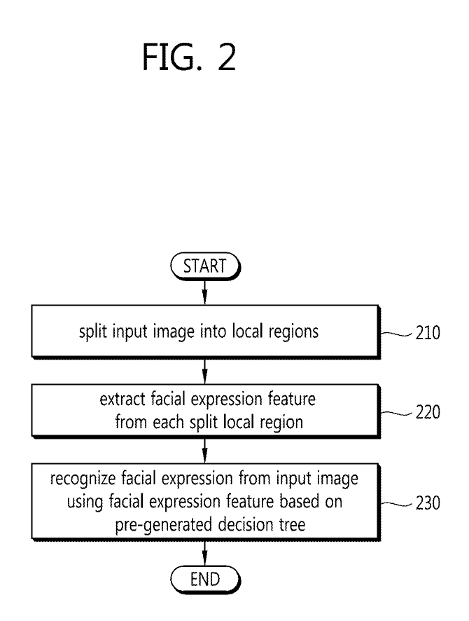

FIG. 2 is a flowchart illustrating a method of recognizing a facial expression according to an embodiment of the present invention. Hereinafter, a method of recognizing a facial expression from an input image using a decision tree generated through the above-described process by a facial expression recognition apparatus according to the present invention is described.

When inputting an image containing a facial region, the facial expression recognition apparatus splits the facial region contained in the image into local regions (step 210). The facial expression recognition apparatus extracts a facial expression feature from each local region using a predetermined feature extracting algorithm (step 220). At this time, the facial expression recognition apparatus may detect the facial region from the input image using an ASM and split the detected facial region into the local regions, and the facial expression recognition apparatus may extract facial expression features from each of the local regions using an LBP algorithm, ULBP algorithm, and eigenface algorithm.

Thereafter, the facial expression recognition apparatus classify the facial expressions into two classes until one facial expression is contained in one class, determines a facial expression feature (or local region) for each classification to generate a decision tree, and based on the decision tree, recognizes a facial expression from the input image using the extracted facial expression feature (step 230). The decision tree may be generated by repeatedly performing the process of classifying the facial expressions into two facial expression combinations, classify the facial expressions into two classes based on the number of true recognitions computed per local region according to the facial expression combinations, and determining a facial expression feature (or local region) for the classification. The number of true recognitions may be computed by determining whether true recognition is conducted on the classification based on the discriminant feature extracted from the training image. Here, the discriminant feature may be extracted by applying at least one or more algorithms of a PCA, an LDA, and an SVM for each of the facial expression features extracted from the training image.

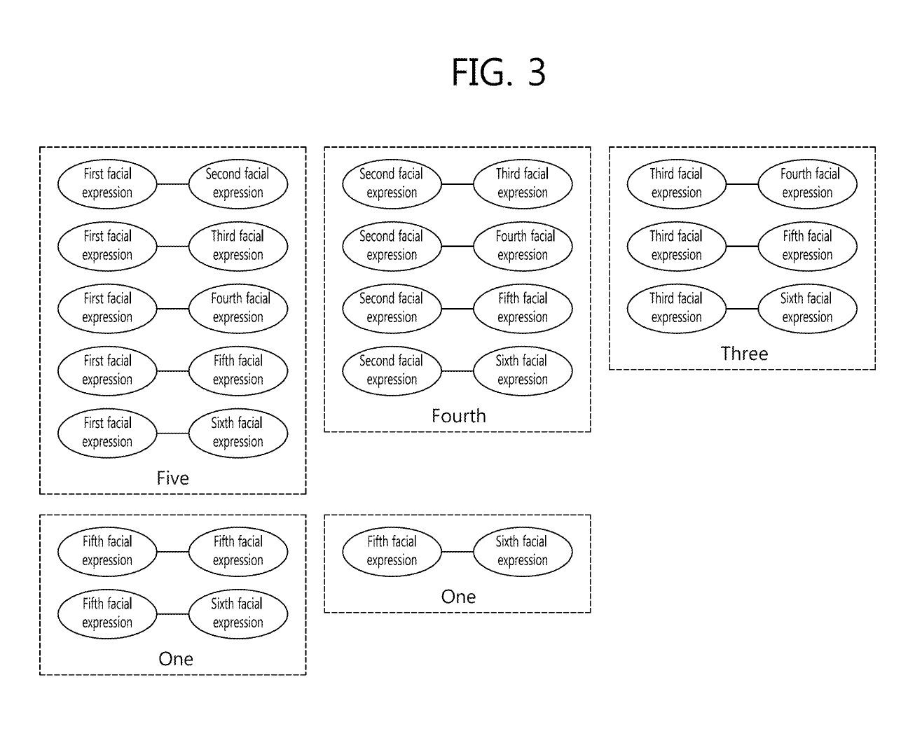

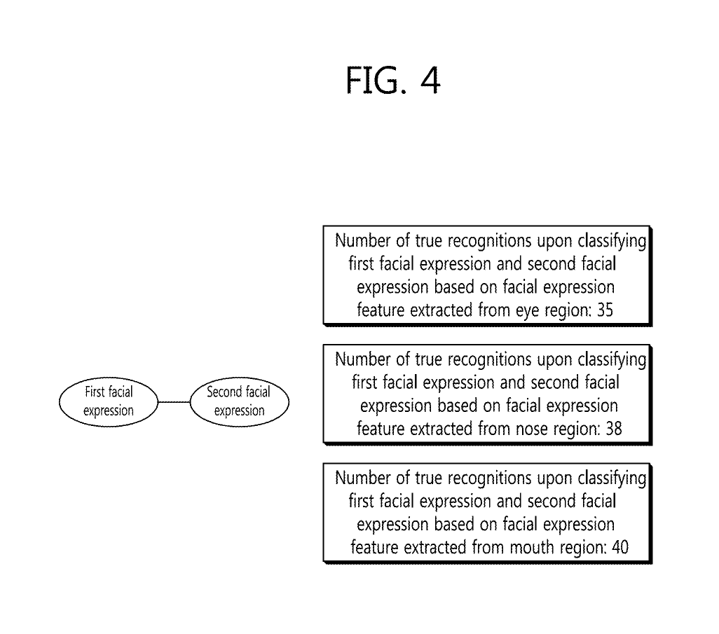

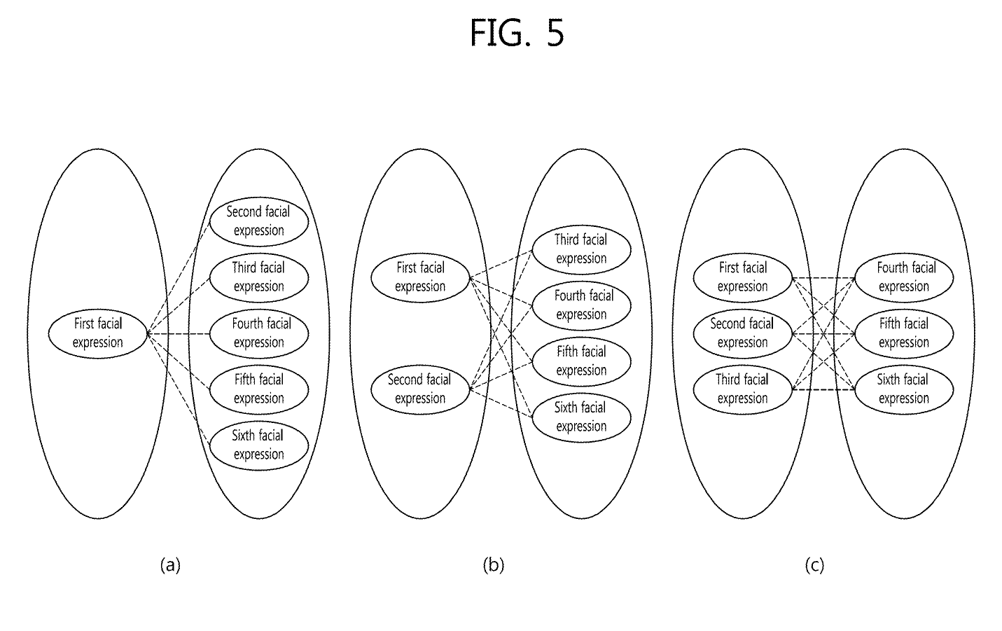

FIG. 3 is a view illustrating facial expression combinations when six facial expressions are classified into two according to an embodiment of the present invention, and FIGS. 4 and 5 are views illustrating an example process of generating a decision tree according to an embodiment of the present invention. Hereinafter, an example is described in which six facial expressions (first facial expression through six facial expression) are classified into two facial expression combinations with facial expression features extracted from three local regions (eye region, nose region, and mouth region), and based on the facial expression combinations, a decision tree is generated.

When the six facial expressions each are classified into two facial expression combinations, there may be 15 facial expression combinations as shown in FIG. 3. Accordingly, the facial expression recognition apparatus according to the present invention extracts dimension-shrunken discriminant features in order to well classify facial expressions with per-local region facial expression features respectively corresponding to the fifteen facial expression combinations so as to generate a decision tree for facial expression recognition. The facial expression recognition apparatus computes the number of true recognition when classifying each facial expression combination with a corresponding facial expression feature based on the extracted discriminant features.

As an example, FIG. 4 shows an example in which upon classifying into a first facial expression and a second facial expression with facial expression features extracted from the eye region of each of 50 training images, 35 are true-recognized, and upon classifying into a first facial expression and a second facial expression with facial expression features extracted from the nose region of each training image, 38 are true-recognized, and upon classifying into a first facial expression and a second facial expression with facial expression features extracted from the mouth region of each training image, 40 are true-recognized. When the number of per-facial expression feature true recognitions for each facial expression combination is computed through the above-described process, the facial expression recognition apparatus finds a facial expression combination that allows the average of sums of the true recognitions to be maximized and based on the facial expression combination classifies the facial expressions into two classes.

For instance, when six facial expressions are classified into two classes, case (a) has six combinations, case (b) 15 combinations, and case (c) 19 combinations as shown in FIG. 5. Accordingly, a total of 40 combinations is available. Therefore, the facial expression recognition apparatus according to the present invention determines a decision tree by detecting a facial expression combination that allows the average of sums of the numbers of true recognitions computed per local region on each facial expression combination to be maximized and classifying the facial expressions into two classes and determines the facial expression feature used upon classification as a facial expression feature for the classification. As an example, in the event that the average is 32 when the facial expressions are classified as shown in FIG. 5(a) with the facial expression feature extracted from the mouth region, the average is 46 when the facial expressions are classified as shown in FIG. 5(b), and the average is 39 when the facial expressions are classified as shown in FIG. 5(c), the facial expression recognition apparatus may classify the facial expressions as shown in Fig. (b) and may determine the facial expression feature used for the classification as a facial expression feature extracted from the mouth region.

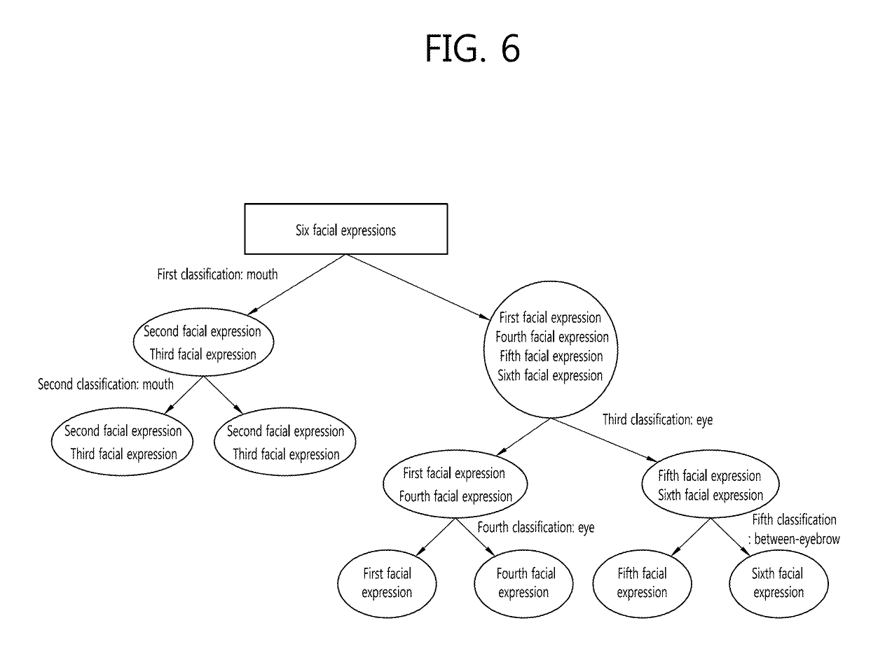

FIG. 6 is a view illustrating an example decision tree according to an embodiment of the present invention.

According to the present invention, when the facial expressions are classified into two classes as described above, the facial expression recognition apparatus generates an adaptive decision tree as shown in FIG. 6 by repeatedly performing the above-described process until no more classification is made on the facial expressions. In other words, a process of classifying the facial expressions into two classes from a large branch to a small branch and determining a facial expression feature for the classification is systemically repeated.

For example, in case the facial expressions are classified into (second facial expression, third facial expression) and (first facial expression, fourth facial expression, fifth facial expression, sixth facial expression) with a facial expression feature extracted from the mouth region (first classification), if the average of sums of the numbers of true recognitions is maximum, the facial expressions are classified into two classes as shown in FIG. 6. In such case, (second facial expression, third facial expression) are naturally classified into (second facial expression) and (third facial expression) (second classification), and at this time, only a facial expression feature that enables the second facial expression and the third facial expression to be classified well can be identified based on the maximum true recognition value.

(first facial expression, fourth facial expression, fifth facial expression, sixth facial expression) are subjected to a process of classifying four facial expressions into two target classes and are thus classified into two classes ((first facial expression, fourth facial expression) and (fifth facial expression, sixth facial expression) (third classification), and a corresponding facial expression feature is the one extracted from an eye region based on the maximum true recognition value.

(first facial expression, fourth facial expression) and (fifth facial expression, sixth facial expression), respectively, are also classified into (first facial expression) and (fourth facial expression) and (fifth facial expression) and (sixth facial expression) (fourth classification and fifth classification). FIG. 6 shows an example in which facial expression features are extracted from an eye region and a between-eyebrow region based on the maximum true recognition value. As such, the facial expression recognition apparatus may reduce error rate upon facial expression recognition and efficiently recognize a facial expression by adaptively generating a decision tree for optimally classifying facial expressions.

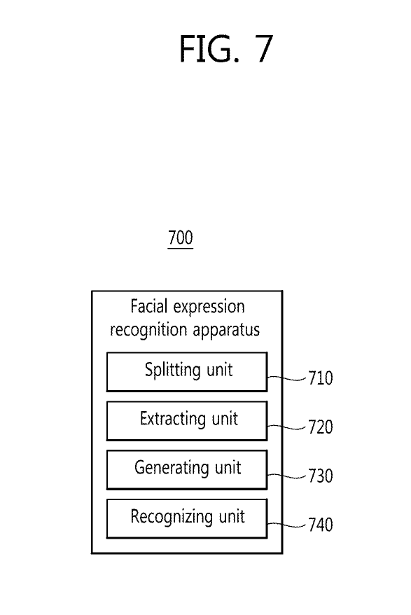

FIG. 7 is a block diagram illustrating a facial expression recognition apparatus according to an embodiment of the present invention.

According to the present invention, the facial expression recognition apparatus 700 may include a splitting unit 710, an extracting unit, a generating unit 730, and a recognizing unit 740 as shown in FIG. 7.

The splitting unit 710 splits a facial region contained in an input image into local regions. As an example, the splitting unit 710 may detect a facial region from an input image using an ASM and may split the detected facial region into local regions.

The extracting unit 720 extracts a facial expression feature from each of the local regions split by the splitting unit 710 using a preset feature extracting algorithm. At this time, the extracting unit 720 may use any one of LBP-based algorithms such as an LBP algorithm or a ULBP algorithm and an eigenface algorithm.

The generating unit 730 generates a decision tree for facial expression recognition by repeatedly classifying facial expressions into two classes until one facial expression is contained in one class and determining a facial expression feature (or local region) for each classification. As an example, the generating unit 730 may classify facial expressions each into two facial expression combinations and generate the decision tree based on the number of true recognitions computed per local region according to the facial expression combinations. Here, the number of true recognitions may be computed by determining whether true recognition is performed on the classification based on the discriminant feature extracted from a training image, and the discriminant feature may be extracted by applying at least one algorithm of PCA, LDA, and SVM per facial expression feature extracted from the training image. Specifically, the generating unit 730 may generate the decision tree by repeatedly performing a process of classifying the facial expressions into two classes based on the facial expression combination that enables the average of sums of the numbers of the true recognitions to be maximum and determining a facial expression feature (or local region) for the classification. Meanwhile, the decision tree may be generated by a separate apparatus (not shown) as necessary. In such case, the facial expression recognition apparatus 700 may receive the decision tree generated from the separate apparatus and use the decision tree.

The recognizing unit 740 recognizes a facial expression from the input image using the facial expression feature extracted by the extracting unit 720 based on the generated decision tree.

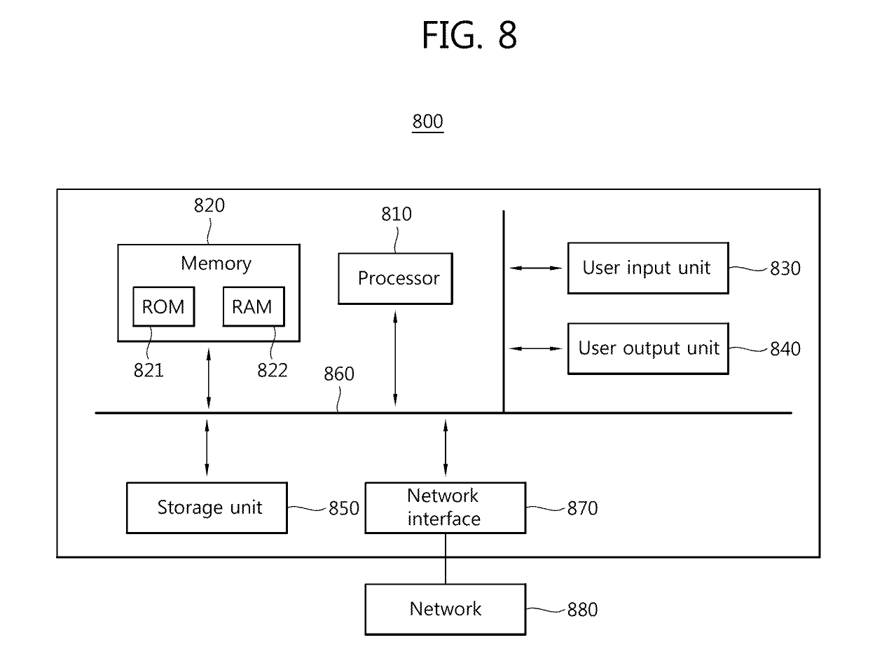

FIG. 8 is a block diagram illustrating a computer system including a facial expression recognition apparatus according to an embodiment of the present invention.

The facial expression recognition apparatus according to the present invention may be implemented in a computer system 800. As shown in FIG. 8, the computer system 800 includes at least one processor 810, a memory 820, a user input unit 830, a user output unit 840, and a storage unit 850 that may communicate with each other via a bus 860. Further, the computer system 800 may include a network interface 870 for connection with a network 880. The processor 810 may be a CPU (Central Processing Unit) or a semiconductor device that may execute a processing command stored in the memory 820 and/or storage unit 850. The memory 820 and the storage unit 850 may include various types of volatile or non-volatile storage media. For example, the memory 820 may include a ROM (Read-Only Memory) 821 or a RAM (Random Access Memory) 822.

While the inventive concept has been shown and described with reference to exemplary embodiments thereof, it will be apparent to those of ordinary skill in the art that various changes in form and detail may be made thereto without departing from the spirit and scope of the inventive concept as defined by the following claims.

What is claimed is:

1. A method of recognizing a facial expression by a facial expression recognition apparatus, the method comprising:
splitting a facial region included in an input image into local regions;
extracting a facial expression feature from each of the local regions using a preset feature extracting algorithm; and
recognizing a facial expression from the input image using the extracted facial expression feature based on a decision tree generated by repeatedly classifying facial expressions into two classes until one facial expression is contained in one class and determining a facial expression feature for a corresponding classification.

2. The method of claim 1, wherein splitting into the local regions includes detecting the facial region from the input image using an ASM (Active Shape Model) and splitting the detected facial region into the local regions.

3. The method of claim 1, wherein the feature extracting algorithm is any one of an LBP (Local Binary Pattern)-based algorithm and an eigenface algorithm.

4. The method of claim 1, wherein the decision tree is generated based on the number of true recognitions computed per local region according to two facial expression combinations classified from each of the facial expressions.

5. The method of claim 4, wherein the number of true recognitions is computed by determining whether true recognition is conducted on the classification based on a discriminant feature extracted from a training image.

6. The method of claim 5, wherein the discriminant feature is extracted by applying at least one or more of a PCA (Principal Component Analysis) algorithm and an LDA (Linear Discriminant Analysis) algorithm or an SVM (Support Vector Machine) algorithm per facial expression feature extracted from the training image.

7. The method of claim 4, wherein the decision tree is generated by repeatedly performing a process of classifying the facial expressions into two classes based on the facial expression combination so that an average of sums of the numbers of the true recognitions is maximized and determining a facial expression feature for a corresponding classification.

8. A facial expression recognition apparatus, comprising:
a splitting unit splitting a facial region included in an input image into local regions;
an extracting unit extracting a facial expression feature from each of the local regions using a preset feature extracting algorithm; and
a recognizing unit recognizing a facial expression from the input image using the extracted facial expression feature based on a decision tree generated by repeatedly classifying facial expressions into two classes until one facial expression is contained in one class and determining a facial expression feature for a corresponding classification.

9. The facial expression recognition apparatus of claim 8, wherein the splitting unit detects the facial region from the input image using an ASM (Active Shape Model) and splits the detected facial region into the local regions.

10. The facial expression recognition apparatus of claim 8, wherein the extracting unit extracts a facial expression feature from each of the local regions using any one of an LBP (Local Binary Pattern)-based algorithm and an eigenface algorithm.

11. The facial expression recognition apparatus of claim 8, wherein the decision tree is generated based on the number of true recognitions computed per local region according to two facial expression combinations classified from each of the facial expressions.

12. The facial expression recognition apparatus of claim 11, wherein the number of true recognitions is computed by determining whether true recognition is conducted on the classification based on a discriminant feature extracted from a training image.

13. The facial expression recognition apparatus of claim 12, wherein the discriminant feature is extracted by applying at least one or more of a PCA (Principal Component Analysis) algorithm and an LDA (Linear Discriminant Analysis) algorithm or an SVM (Support Vector Machine) algorithm per facial expression feature extracted from the training image.

14. The facial expression recognition apparatus of claim 11, wherein the decision tree is generated by repeatedly performing a process of classifying the facial expressions into two classes based on the facial expression combination so that an average of sums of the numbers of the true recognitions is maximized and determining a facial expression feature for a corresponding classification.

15. A method of generating a decision tree for facial expression recognition by a facial expression recognition apparatus, the method comprising:
splitting a facial region included in a training image into local regions;
extracting a facial expression feature from each of the local regions using a preset feature extracting algorithm;
extracting a discriminant feature for determining whether true recognition is conducted on a facial expression classification from the facial expression feature;
classifying facial expressions into two facial expression combinations per facial expression feature and computing the number of per-local region true recognitions for each classification based on the discriminant feature; and
classifying the facial expressions into two classes based on the number of the true recognitions and determining a facial expression feature for a corresponding classification.

16. The method of claim 15, wherein splitting into the local regions includes detecting the facial region from the input image using an ASM (Active Shape Model) and splitting the detected facial region into the local regions.

17. The method of claim 15, wherein extracting the facial expression feature includes extracting a facial expression feature from each of the local region using any one of an LBP (Local Binary Pattern)-based algorithm and an eigenface algorithm.

18. The method of claim 15, wherein extracting the discriminant feature includes extracting the discriminant feature by applying at least one or more of a PCA (Principal Component Analysis) algorithm and an LDA (Linear Discriminant Analysis) algorithm or an SVM (Support Vector Machine) algorithm per facial expression feature.

19. The method of claim 15, wherein determining the discriminant feature includes classifying the facial expressions into two classes based on the facial expression combination so that an average of sums of the numbers of the true recognitions is maximized and determining a facial expression feature for a corresponding classification.

20. The method of claim 15, further comprising, after determining the facial expression feature, repeatedly performing a process of repeatedly classifying the facial expressions into two classes until one facial expression is included in one class and determining the facial expression feature.
